(19) United States
(12) Patent Application Publication
(10) Pub. No.: US 2024/0397525 A1
(43) Pub. Date: Nov. 28, 2024

(54) METHODS, DEVICES, AND SYSTEMS FOR MULTIPLE CARRIER TRANSMISSION MECHANISM

(71) Applicant: ZTE Corporation, Shenzhen (CN)

(72) Inventors: Jing SHI, Shenzhen (CN); Xianghui HAN, Shenzhen (CN); Shuaihua KOU, Shenzhen (CN); Xingguang WEI, Shenzhen (CN)

(73) Assignee: ZTE Corporation, Shenzhen (CN)

(21) Appl. No.: 18/794,107

(22) Filed: Aug. 5, 2024

Related U.S. Application Data
(63) Continuation of application No. PCT/CN2022/130095, filed on Nov. 4, 2022.

(51) Int. Cl. H04W 72/232; H04L 5/00

(52) U.S. Cl. CPC H04W 72/232; H04L 5/0091

(57) ABSTRACT

The present disclosure describes methods, system, and devices for multiple carrier transmission mechanism. One method includes receiving a configuration of a value for a set of cells, and receiving a configuration of a search space of a multi-cell scheduling downlink control information (MC-DCI), wherein: the set of cells is configured for multi-cell scheduling and at least one of the set cells are scheduled by the MC-DCI on a physical downlink control channel (PDCCH) candidate on a scheduling cell, the value is used to determine control channel element (CCE) indexes of the search space corresponding to the PDCCH candidate, and the search space is configured on at least one of the following: the scheduling cell carrying the MC-DCI or a scheduled cell in the set of cells.

### TECHNICAL FIELD

The present disclosure is directed generally to wireless communications. Particularly, the present disclosure relates to methods, devices, and systems for multiple carrier transmission mechanism.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Carrier aggregation (CA) is used to improve the performance of wireless communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI. There are various problems/issues associated with the multi-cell PUSCH/PDSCH scheduling with the single scheduling DCI.

The present disclosure describes various embodiments for multiple carrier transmission mechanism, which may address at least one of issues/problems associated with multi-cell PUSCH/PDSCH scheduling with a single scheduling DCI, thus improving the efficiency and/or performance of the wireless communication.

### SUMMARY

This document relates to methods, systems, and devices for wireless communication, and more specifically, for multiple carrier transmission mechanism, which may address at least one of issues/problems associated with multi-cell PUSCH/PDSCH scheduling with a single scheduling DCI, thus improving the efficiency and/or performance of the wireless communication.

In one embodiment, the present disclosure describes a method for wireless communication. The method, performed by a wireless communication device, includes: receiving a configuration of a value for a set of cells, and receiving a configuration of a search space of a multi-cell scheduling downlink control information (MC-DCI), wherein: the set of cells is configured for multi-cell scheduling and at least one of the set cells are scheduled by the MC-DCI on a physical downlink control channel (PDCCH) candidate on a scheduling cell, the value is used to determine control channel element (CCE) indexes of the search space corresponding to the PDCCH candidate, and the search space is configured on at least one of the following: the scheduling cell carrying the MC-DCI or a scheduled cell in the set of cells.

In one embodiment, the present disclosure describes a method for wireless communication. The method, performed by a wireless communication node, includes: determining a switching gap of uplink (UL) transmitter (Tx) switching with more than two bands involved; or determining a minimum separation time between two UL Tx switchings.

In one embodiment, the present disclosure describes a method for wireless communication. The method, performed by a wireless communication device, includes: determining a switching gap of uplink (UL) transmitter (Tx) switching with more than two bands involved; or determining a minimum separation time between two UL Tx switchings.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of an exemplary embodiment for wireless communication.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of an exemplary embodiment for wireless communication.

FIG. 6A shows a schematic diagram of an exemplary embodiment for wireless communication.

FIG. 6B shows a schematic diagram of an exemplary embodiment for wireless communication.

FIG. 7A shows a schematic diagram of an exemplary embodiment for wireless communication.

FIG. 7B shows a schematic diagram of an exemplary embodiment for wireless communication.

FIG. 7C shows a schematic diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for multiple carrier transmission mechanism.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC).

Carrier aggregation (CA) is used to improve the performance of wireless communication system in 4G and 5G and further communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI.

When multi-cell scheduling with a single scheduling DCI format (e.g., format 0_X and/or 1_X) are introduced for a set of cells, a DCI size of the DCI format 0_X/1_X is counted on one cell among the set of cells, a blind decode and/or control channel element (BD/CCE) of the DCI format 0_X/1_X is counted on one cell among the set of cells. Search space of the DCI format 0_X/1_X is configured on one cell of the set of cells and associated with the search space of the scheduling cell with the same search space identifier (ID). For monitoring PDCCH candidates for a set of cells which is configured for multi-cell scheduling, a value of n_CI in the search space equation is determined by a value configured for the set of cells. There are various problems/issues associated with how to determine n_CI for a set of cells and a UE-specific search space (USS) with the DCI format 0_X/1_X on one cell among the set of cells.

The various embodiments and implementations described in the present disclosure include methods and devices for multiple carrier transmission mechanism, addressing at least one of the issues/problems discussed in the present disclosure.

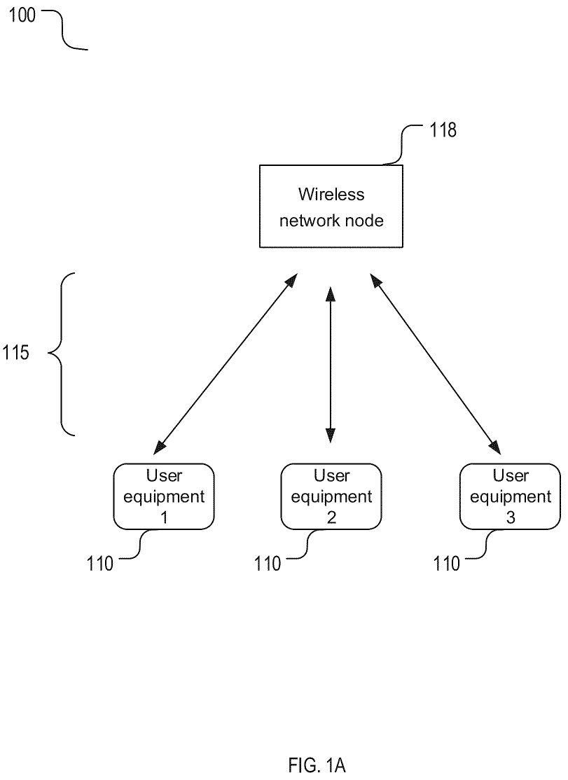

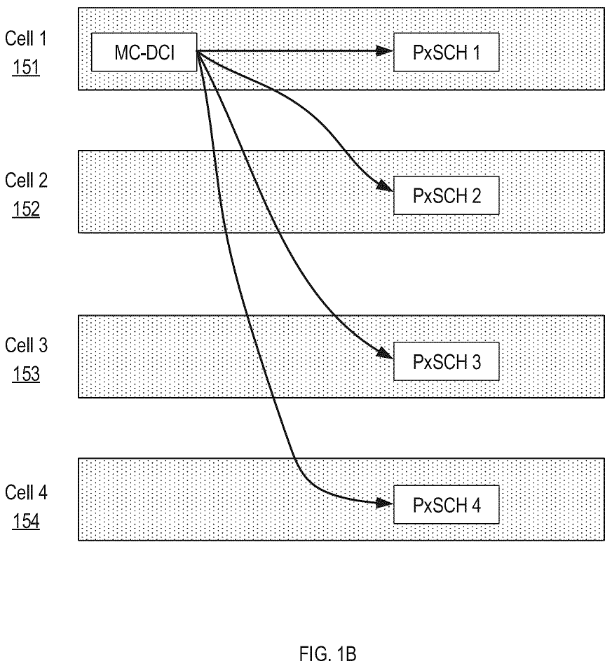

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

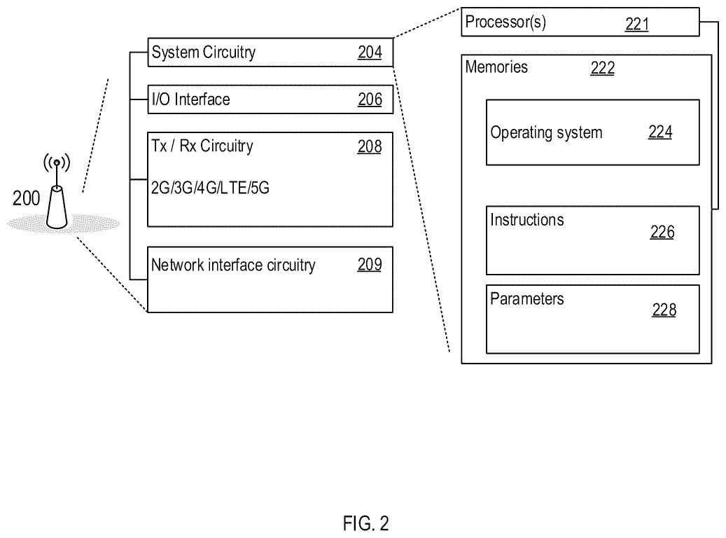

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

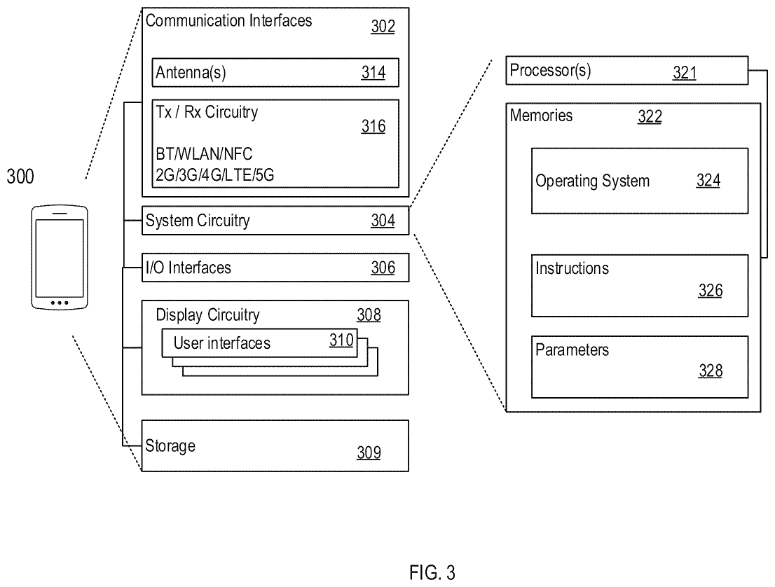

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for multiple carrier transmission mechanism in a telecommunication system, which may be implemented, partly or totally, on the network base station and/or the user equipment described above in FIGS. 2-3. The various embodiments in the present disclosure may enable efficient carrier transmission in the telecommunication system, which may increase the resource utilization efficiency and/or boost latency performance of URLLC traffic.

In some implementations for multi-cell scheduling, under a normal situation, one scheduled cell may be only configured with single scheduling cell. FIG. 1B shows a multi-cell scheduling, wherein a first cell (Cell 1, 151) may be a scheduling cell, a second cell (Cell 2, 152) may be a scheduled cell, a third cell (Cell 3, 153) may be another scheduled cell, and a fourth cell (Cell 4, 154) may be another scheduled cell. A scheduled cell may be only configured with one scheduling cell and a single multi-cell scheduling DCI (MC-DCI), which may be a DCI format 0_X/1_X and carried by PDCCH, may be used to schedule multi-PxSCH on multi cells, with each PxSCH on one cell. The term “PxSCH” may be used to refer to either a physical downlink shared channel (PDSCH) or a physical uplink shared channel (PUSCH). As shown in FIG. 1B, there is only one scheduling cell for a scheduled cell, and MC-DCI and/or single cell scheduling DCI (SC-DCI), which is a legacy DCI forma (e.g. DCI format 0_1/1_1), may be supported on the scheduling cell for a scheduled cell. MC-DCI may be a new DCI format 0_X/1_X.

In some implementations, for example in a normal case, a DCI size and/or blind decode/control channel element (BD/CCE) of the PDCCH carried the multi-cell scheduling DCI are counted on one cell among the set of cells. In some implementations, the BD is corresponding to the Maximum number M_{PDCCH}^{max,slot,μ} of monitored PDCCH candidates per slot/span for a downlink (DL) bandwidth part (BWP) with a subcarrier spacing (SCS) configuration μ∈{0, 1,2,3} for a single serving cell. The CCE is corresponding to the maximum number C_{PDCCH}^{max,slot,μ} of non-overlapped CCEs per slot/span for a DL BWP with SCS configuration μ93 {0, 1,2,3} for a single serving cell.

In some implementations, there may be at least two conditions for multiple cell scheduling.

One condition: for a set of cells configured for multi-cell scheduling, existing DCI size budget is maintained on each cell of the set of cells; DCI size of DCI format 0_X/1_X is counted on one cell among the set of cells; BD/CCE of DCI format 0_X/1_X is counted on one cell among the set of cells; search space of DCI format 0_X/1_X is configured on one cell of the set of cells and associated with the search space of the scheduling cell with the same search space ID.

Another condition: for monitoring PDCCH candidates for a set of cells which is configured for multi-cell scheduling, the n_CI in the search space equation is determined by a value configured for the set of cells.

In some implementations, the maximum number M_{PDCCH}^{max,slot,μ} of monitored PDCCH candidates per slot for a DL BWP with SCS configuration μ93 {0, 1,2,3} for a single serving cell is shown as Table 1, wherein μ93 {0, 1,2,3} is corresponding to 15 khz, 30 khz, 60 khz and 120 khz respectively. In some implementations, the maximum number C_{PDCCH}^{max,slot,μ} of non-overlapped CCEs per slot for a DL BWP with SCS configuration u E {0, 1,2,3} for a single serving cell is shown as Table 2.

TABLE 1
Maximum number of monitored PDCCH candidates
(may be also regarded as Blind Decodes (BDs))

| | Maximum number of monitored PDCCH candidates per |
|---|---|
| μ | slot and per serving cell M_{PDCCH}^{max, slot, μ} |
| 0 | 44 |
| 1 | 36 |
| 2 | 22 |
| 3 | 20 |

TABLE 2
Maximum number of non-overlapped CCEs

| | Maximum number of non-overlapped CCEs per slot |
|---|---|
| μ | and per serving cell C_{PDCCH}^{max, slot, μ} |
| 0 | 56 |
| 1 | 56 |
| 2 | 48 |
| 3 | 32 |

In some implementations, when a UE is configured with N_{cells}^{DL,μ} downlink cells with DL BWPs having SCS configuration μ, where Σ_{μ=0}³N_{cells}^{DL,μ}>N_{cells}^{cap}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}=└N_{cells}^{cap}·M_{PDCCH}^{max,slot,μ}·N_{cells}^{DL,μ}/Σⱼ₌₀³N_{cells}^{DL,j}┘ PDCCH candidates or more than C_{PDCCH}^{total,slot,μ}=└N_{cells}^{cap}·C_{PDCCH}^{max,slot,μ}·N_{cells}^{DL,μ}/Σⱼ₌₀³N_{cells}^{DL,j}┘ non-overlapped CCEs per slot on the active DL BWP(s) of scheduling cell(s) from the N_{cells}^{DL,μ} downlink cells.

In some implementations, there may be a DCI size budget for a UE per serving cell. That is, UE is not expected to handle the total number of different DCI sizes configured to monitor is more than 4 for the cell; or the total number of different DCI sizes with C-RNTI configured to monitor is more than 3 for the cell.

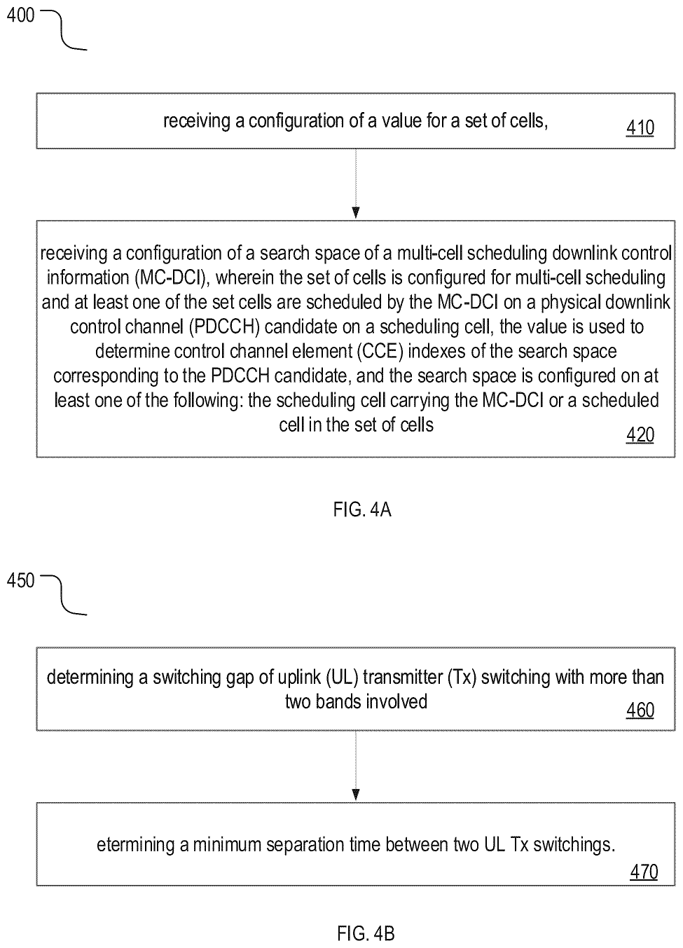

Referring to FIG. 4A, the present disclosure describes various embodiments of a method 400 for wireless communication. The method 400 may be performed by a wireless communication device (e.g., a user equipment). The method 400 may include a portion or all of the following steps: step 410, receiving a configuration of a value for a set of cells, and/or step 420, receiving a configuration of a search space of a multi-cell scheduling downlink control information (MC-DCI), wherein the set of cells is configured for multi-cell scheduling and at least one of the set cells are scheduled by the MC-DCI on a physical downlink control channel (PDCCH) candidate on a scheduling cell, the value is used to determine control channel element (CCE) indexes of the search space corresponding to the PDCCH candidate, and the search space is configured on at least one of the following: the scheduling cell carrying the MC-DCI or a scheduled cell in the set of cells. In some implementations, a portion or all of the steps in method 400 may be performed by a wireless node (e.g., a gNB).

In some implementations, the value is configured as a same value as a carrier indicator filed (CIF) of the scheduled cell.

In some implementations, the value is configured on the scheduling cell or within signalling of a cell group as a different value from each CIF of the set of the cells; and/or at least one of the following of the MC-DCI is configured to count on one scheduled cell: at least one DCI size, at least one blind decode, or at least one non-overlapped control channel element (CCE).

In some implementations, the value is configured on the scheduled cell as a different value from each CIF of the set of the scheduled cells; and/or at least one of the following of the MC-DCI is determined to count on the scheduled cell: at least one DCI size, at least one blind decode, or at least one non-overlapped control channel element (CCE).

In some implementations, the value is an integer larger than 7.

In some implementations, a first user equipment-specific search space (USS) with an identifier (ID) is configured on the scheduling cell; a second USS of MC-DCI is configured with the same ID on the scheduled cell; and/or both the first USS and the second USS comprises at least one candidate.

In some implementations, the scheduling cell belongs to the set of cells and is not the scheduled cell configured with the second USS; and/or

one of the scheduled cell configured with the second USS and the scheduling cell configured with first USS is used to determine resource to monitor the MC-DCI.

In some implementations, the scheduling cell does not belong to the set of cells; and/or the scheduled cell configured with the second USS is used to determine resource to monitor the MC-DCI.

In some implementations, aUSS of MC-DCI with an ID is configured on the scheduling cell with at least one candidate, and no USS with the same ID is configured for other cells in the set of cells; in response to the scheduling cell belonging to the set of the scheduled cells, the scheduling cell is used to determine resource to monitor the MC-DCI; and/or in response to the scheduling cell not belonging to the set of the scheduled cells, one scheduled cell is used to determine resource to monitor the MC-DCI.

In some implementations, according to a predefined rule or a RRC configuration, at least one DCI size, BD, or CCE of the MC-DCI is determined to be counted on one of the set of cells, or on another cell of the set of cells in response to the scheduled cell on which the DCI size, BD, or CCE is counted is deactivated or dormant.

In some implementations, the cell of the set of cells is determined according to one of following: configuring or predefining a cell ID order to determine the cell counted the DCI size, BD, or CCE of the MC-DCI; determining the scheduling cell in response to the scheduling cell belonging to the set of cells; determining by ascending or descending order based on the cell ID; and/or determining the scheduling cell regardless of the scheduling cell belongs to the set of cells or not.

In some implementations, a USS of the MC-DCI is not configured for a second cell in the set of cells; a USS of a single-cell scheduling downlink control information (SC-DCI) is not configured for the second cell in the set of cells; and/or a cell number of the second cell to count on a BD/CCE budget of a sub-carrier spacing of the scheduling cell is determined to be counted in a scaling factor.

In some implementations, the scaling factor is determined by at least one of following: the scaling factor is equal to 1 in case that the PDCCH candidates monitored in active downlink (DL) bandwidth parts (BWPs) of the scheduling cell comprises MC-DCI candidates configured on other cell except the second cell and is also regarded as the PDCCH candidates for the second cell; and/or the scaling factor is equal to 0 in case that the PDCCH candidates monitored in active downlink (DL) bandwidth parts (BWPs) of the scheduling cell comprises MC-DCI candidates configured on other cell except the second cell and is not regarded as the PDCCH candidates for the second cell.

Referring to FIG. 4B, the present disclosure describes various embodiments of a method 450 for wireless communication. The method 450 may be performed by either a wireless communication node (e.g., gNB) or a wireless communication device (e.g., a UE). The method 450 may include a portion or all of the following steps: step 460, determining a switching gap of uplink (UL) transmitter (Tx) switching with more than two bands involved; and/or step 470, determining a minimum separation time between two UL Tx switchings.

In various embodiments/implementations in the present disclosure, the term “transmitter” in uplink (UL) transmitter (Tx) switching may be used to refer to a transmitter circuit alone, an antenna component alone, a combination of a transmitter circuit and an antenna component (i.e., a transmitter channel or chain), or the like circuit.

In some implementations, the more than two bands comprises A, B, C, and D, wherein each of A, B, C, and D denotes a separate band; and/or the determining the switching gap comprises: calculating a first switching gap based on a first switching case that switching from A to B and switching from C to D, calculating a second switching gap based on a second switching case that switching from A to D and switching from C to B, and/or deriving the switching gap based on the first switching gap and the second switching gap.

In some implementations, the deriving the switching gap based on the first switching gap and the second switching gap comprises: determining a maximum value of the first switching gap and the second switching gap as the switching gap.

In some implementations, the determining the switching gap comprises: the determining the switching gap is according to at least one of the following: a radio resource control (RRC) configuration indicating the first switching case or the second switching case; a first predefined rule based on cell indexes in an order from low to high to determine one of switching cases; a second predefined rule based on cell indexes in an order from high to low to determine one of switching cases; and/or a third predefined rule based on available band pairs that are reported.

In some implementations, the determining the minimum separation time comprises: defining a switching within a reference slot based on a maximum or minimum subcarrier spacing (SCS) of carriers involved of the two UL Tx switchings; and/or determining no more than one uplink Tx switching within a reference slot.

In some implementations, in response to reference SCSs for a switching calculated with a preceding switching and as a preceding switching being different, using a smaller SCS or a larger SCS of the reference SCSs as the SCS.

In some implementations, a reference SCS is calculated with a preceding switching as the SCS.

In some implementations, a reference SCS is calculated as a preceding switching as the SCS.

In some implementations, the determining the minimum separation time comprises one of following: in response to bands involved of the two UL Tx switchings being same, defining no more than one UL Tx switching within a reference slot; and in response to bands involved of the two UL Tx switchings being different, determining the minimum separation time between the two UL Tx switchings; and/or in response to carriers involved of the two UL Tx switchings being same, defining no more than one UL Tx switching within a reference slot, and/or in response to carriers involved of the two UL Tx switchings being different, determining the minimum separation time between the two UL Tx switchings.

### Embodiment Set I

In some implementations, based on one of the above described conditions, a BD/CCE of the DCI format 0_X/1_X may be counted on one cell among the set of cells.

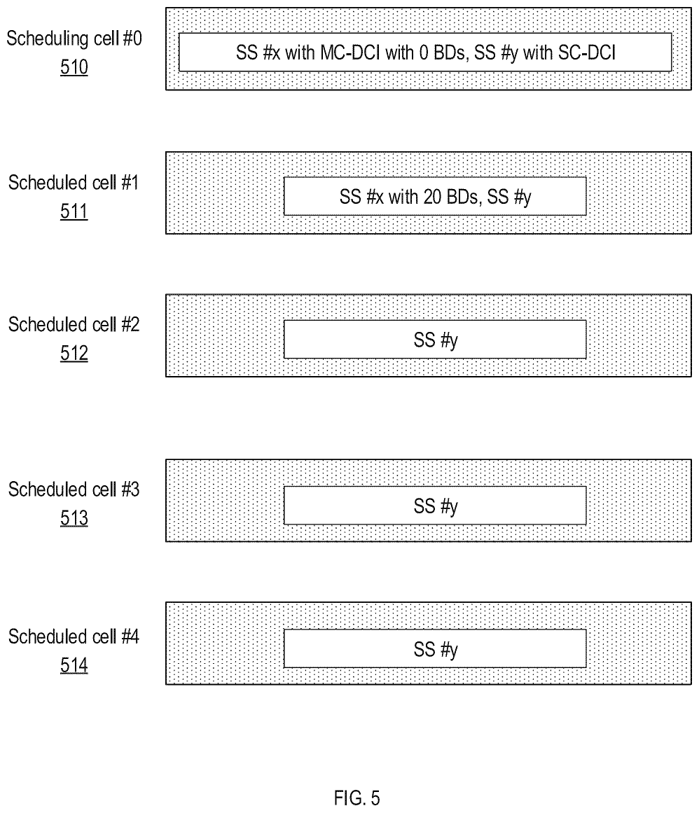

In some implementations, further based on some working assumption, a search space of the DCI format 0_X/1_X may be configured on one cell of the set of cells and associated with the search space of the scheduling cell with the same search space ID. For example, FIG. 5 shows one exemplary implementation of multiple cell scheduling, which includes a scheduling cell (cell #0, 510), a first scheduled cell (Cell #1, 511), a second scheduled cell (Cell #2, 512), a third scheduled cell (Cell #3, 513), and/or a fourth scheduled cell (Cell #4, 514). A search space with a particular ID (e.g., SS #x) of DCI format 0_X/1_X is configured on cell #1 with 20 BDs, and the search space of the scheduling cell #0 with the same search space #x is configured with 0 BDs. The DCI size of DCI format 0_X/1_X and BD/CCE of DCI format 0_X/1_X is counted on cell #1.

In some implementations, for n_CI, based on another of the above described conditions, for monitoring PDCCH candidates for a set of cells which is configured for multi-cell scheduling, the n_CI in the search space equation is determined by a value configured for the set of cells. In some implementations, the search space equation may include the following:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

In some implementations, when a UE is configured with CrossCarrierSchedulingConfig for a serving cell the carrier indicator field value corresponds to the value indicated by CrossCarrierSchedulingConfig.

In some implementations, for an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

In some implementations, a UE does not expect to monitor PDCCH candidates on an active DL BWP of a secondary cell if the UE is configured to monitor PDCCH candidates with carrier indicator field corresponding to that secondary cell in another serving cell. For the active DL BWP of a serving cell on which the UE monitors PDCCH candidates, the UE monitors PDCCH candidates at least for the same serving cell. In some implementations, for a search space set s associated with CORESET p, the CCE indexes for aggregation level L corresponding to PDCCH candidate m_{s,n}_{_{CI}}^{(L)} of the search space set in slot n_{s,f}^{μ} for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

wherein: for any CSS, Y_{p,n}_{_{s,f}}^{μ}=0; for a USS, Y_{p,n}_{_{s,f}}^{μ}=(Aₚ·Y_{p,n}_{_{s,f}}^{μ}−1)modD, Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is the number of CCEs, numbered from 0 to N_{CCE,p}−1, in CORESET p and, if any, per RB set; n_{CI} is the carrier indicator field value if the UE is configured with a carrier indicator field by CrossCarrierSchedulingConfig for the serving cell on which PDCCH is monitored, except for scheduling of the serving cell from the same serving cell in which case n_{CI}=0; otherwise, including for any CSS, n_{CI}=0; m_{s,n}_{_{CI}}^{(L)}=0, . . . , M_{s,n}_{_{CI}}^{(L)}−1, where M_{s,n}_{_{CI}}^{(L)} is the number of PDCCH candidates the UE is configured to monitor for aggregation level L of a search space set s for a serving cell corresponding to n_{CI}; for any CSS, M_{s,max}^{(L)}=M_{s,0}^{(L)}; for a USS, M_{s,max}^{(L)} is the maximum of M_{s,n}_{_{CI}}^{(L)} over all configured n_{CI} values for a CCE aggregation level L of search space set s; and/or the RNTI value used for N_{RNTI} is the C-RNTI.

In some implementations, for legacy DCI, n_CI is given by the carrier indicator field configured for CCS from the scheduling cell to the scheduled cell. There may be no need to change that. For MC-DCI, it is simple when n_CI is explicitly configured by higher layers. Since a group of cells would be configured to be co-scheduled by a MC-DCI, a corresponding n_CI value may also be configured for that group of cells.

In some implementations, the M_{s,n}_{_{CI}}^{(L)} is the number of PDCCH candidates the UE is configured to monitor for aggregation level L of a search space set s for a serving cell corresponding to n_{CI} which may only for one cell.

In some implementations, the following methods may be used to determine n_CI for a set of cells and USS with DCI format 0_X/1_X on one cell among the set of cells. In some implementations for monitoring PDCCH candidates for a set of cells which is configured for multi-cell scheduling, the n_CI in the search space equation is determined by a value configured for the set of cells, and a search space of DCI format 0_X/1_X is configured on one cell of the set of cells and associated with the search space of the scheduling cell with the same search space ID.

Method 1: In some implementations, a value configured for the set of cells is determined/configured as a carrier indicator field (CIF) of a cell configured with a search space of a DCI format 0_X/1_X. The n_CI for a set of cells is the CIF of a cell configured with the search space of DCI format 0_X/1_X. The M_{s,n}_{_{CI}}^{(L)} is the number of PDCCH candidates the UE is configured to monitor for aggregation level L of a search space set s comprising MC-DCI for a serving cell corresponding to n_{CI} which is configured with the CIF for the cell.

Method 2: In some implementations, the method includes configuring a n_CI for the set of cells and further comprise one of following.

Method 2-1: In some implementations, the method includes configuring a separate n_CI which is different with each CIF of the cell within the set of cells (on the scheduling cell or cell group) and configuring DCI size and/or BD/CCE of DCI format 0_X/1_X counted on one cell among the set of cells. In this case, the M_{s,n}_{_{CI}}^{(L)} is the number of PDCCH candidates the UE is configured to monitor for aggregation level L of a search space set s configured on one cell of a set of cells and the search space comprises MC-DCI for the set of cells corresponding to n_{CI}.

Method 2-2: In some implementations, the method includes configuring a separate n_CI which is different with each CIF of the cell within the set of cell on one scheduled cell among the set of cells and DCI size and/or BD/CCE of DCI format 0_X/1_X counted on the cell. In this case, the M_{s,n}_{_{CI}}^{(L)} is the number of PDCCH candidates the UE is configured to monitor for aggregation level L of a search space set s configured on one cell of a set of cells and the search space comprises MC-DCI for the set of cells corresponding to n_{CI}.

In some implementations, the n_CI is an integer larger than 7, which is not same with CIF value range 0-7.

Method 2-3: In some implementations, the method includes configuring n_CI (on the scheduling cell or cell group) and DCI size and/or BD/CCE of DCI format 0_X/1_X counted on one cell among the set of cells in case that the n_CI is same with a CIF of the cell.

Method 2-4: In some implementations, the method includes configuring n_CI (on the scheduling cell or cell group) and configuring DCI size and/or BD/CCE of DCI format 0_X/1_X counted on one cell among the set of cells.

Various embodiments/implementations in the present disclosure may improve the performance of wireless communication system by resulting in at least one of the following benefits. For monitoring PDCCH candidates for a set of cells which is configured for multi-cell scheduling, regardless the n_CI in the search space equation is determined by a value configured for the set of cells whether is same or different with the n_CI of one cell of the set of cells, it can be kept the search space of DCI format 0_X/1_X is configured on one cell of the set of cells and count the BD/CCE on one cell either. It is benefit for UE to support this capability to reduce complexity on blind decoding of MC-DCI on the scheduling cell.

### Embodiment Set II

In some implementations, based on one of the above described conditions, a search space of DCI format 0_X/1_X is configured on one cell of the set of cells and associated with the search space of the scheduling cell with the same search space ID. Based on current search space linkage mechanism, one scheduling cell and another scheduled cell are configured with same ID search space. There are various problems/issues. For a non-limiting example: how to ensure the search space of DCI format 0_X/1_X is configured on one cell of the set of cells? For another non-limiting example, further in some implementations, when the cell configured with USS of DCI format 0_X/1_X is deactivated/dormant, how to perform multi-cell scheduling and determine the cell to count the DCI size of DCI format 0_X/1_X and BD/CCE of DCI format 0_X/1_X?

Various embodiments/implementations in the present disclosure may provide the following methods, addressing at least one of the issue/problems described above.

Method 1: In some implementations, a USS of DCI format 0_X/1_X with same ID are configured both scheduled cell and its scheduling cell with more than 0) candidates. For example, a USS #x of DCI format 0_X/1_X is configured on a scheduling cell A, and a USS #x of DCI format 0_X/1_X is configured on a scheduled cell B.

Method 1-1: In some implementations, when the scheduling cell belongs to a set of cells, by predefined rules or RRC configuration to determine one of cells configured with a USS of DCI format 0_X/1_X is used to determine the resource to monitor the DCI format 0_X/1_X, e.g., the scheduled cell B, and the DCI size of DCI format 0_X/1_X and BD/CCE of DCI format 0_X/1_X is also counted on the cell B. In some implementations, when the cell B is deactivated or dormant, the scheduling cell A configured with the USS of DCI format 0_X/1_X is used to monitor the DCI format 0_X/1_X. In some implementations, the DCI size of DCI format 0_X/1_X and BD/CCE of DCI format 0_X/1_X is counted on one cell of the set of cells may be determined by method 2-2, e.g., the scheduling cell A due to the scheduling cell belongs to a set of cells.

Method 1-2: In some implementations, when the scheduling cell does not belong to a set of cells, the scheduled cell B configured with USS of DCI format 0)_X/1_X is used to determine the resource to monitor the DCI format 0_X/1_X, and the DCI size of DCI format 0_X/1_X and BD/CCE of DCI format 0)_X/1_X is also counted on the cell B. In some implementations, the USS of MC-DCI configured on the scheduling cell is discarded by a UE when the scheduling cell is not included in the set of cells which is configured with multi-cell scheduling. In some implementations, the USS of MC-DCI configured on the scheduling cell is configured with zero candidate when the scheduling cell is not included in the set of cells which is configured with multi-cell scheduling. In some implementations, when the cell B is deactivated or dormant, the scheduling cell A configured with the USS of DCI format 0_X/1_X is used to monitor the DCI format 0_X/1_X. In some implementations, the DCI size of DCI format 0_X/1_X and BD/CCE of DCI format 0_X/1_X is counted on one cell of the set of cells can be determined by Method 2-2, e.g., another scheduled cell due to the scheduling cell does not belong to a set of cells.

Method 2: In some implementations, a USS of DCI format 0_X/1_X is configured on a scheduling cell with more than 0 candidates, no USS with the same ID is configured on any scheduled cell. For example, a USS #x of DCI format 0_X/1_X is configured on a scheduling cell A, and no USS #x of DCI format 0_X/1_X is configured on any scheduled cell.

Method 2-1: In some implementations, when the scheduling cell belongs to a set of cells, the scheduling cell A configured with a USS of DCI format 0_X/1_X is used to determine the resource to monitor the DCI format 0_X/1_X. In some implementations, the DCI size of DCI format 0_X/1_X and BD/CCE of DCI format 0_X/1_X is counted on the cell A, or is counted on one cell of the set of cells can be determined by Method 2-2.

Method 2-2: In some implementations, when the scheduling cell does not belong to a set of cells, the scheduling cell A configured with USS of DCI format 0_X/1_X is used to determine the resource to monitor the DCI format 0_X/1_X. In some implementations, by predefined rules or RRC configuration to determine the DCI size of DCI format 0_X/1_X and BD/CCE of DCI format 0_X/1_X is counted on one of set of cells. In some implementations, when the cell is deactivated or dormant, the DCI size of DCI format 0_X/1_X and BD/CCE of DCI format 0_X/1_X is counted on one cell of the set of cells can be determined also by predefined rules or RRC configuration, which may include at least one of the following. In some implementations, a first rule/configuration may include to configure/predefine a cell ID order to determine the cell counted the DCI size of DCI format 0_X/1_X and BD/CCE of DCI format 0_X/1_X. For example, count on the first cell according to the cell ID order. In some implementations, when the first cell is deactivated or dormant, the second cell according to the cell ID order is selected to count the DCI size of DCI format 0_X/1_X and BD/CCE of DCI format 0_X/1_X. In some implementations, a second rule/configuration may include counted on the scheduling cell when the scheduling cell belongs to the set of cells. In some implementations, a third rule/configuration may include according to the cell ID with Ascending or descending order. In some implementations, a fourth rule/configuration may include counted on the scheduling cell regardless of the scheduling cell belongs to the set of cells or not.

Method 3: In some implementations, a USS of DCI format 0_X/1_X is configured on scheduled cell with more than 0 candidates, and a USS with the same ID is configured on its scheduling cell with 0 candidate. In some implementations, (de) activating/dormant the cell configured with the USS of DCI format 0_X/1_X may achieve dynamic enable/disable MC scheduling. In some implementations, the Method 2-2 may be used to change to another cell.

Method 4: In some implementations, when any one of a set of cells is deactivated or dormant, the MC scheduling is disable.

Method 5: In some implementations, when the cell configured with a USS of DCI format 0_X/1_X of a set of cells is deactivated or dormant, the MC scheduling is still workable and the scheduling cell configured with USS of DCI format 0_X/1_X is used to determine the resource to monitor the DCI format 0_X/1_X.

### Embodiment Set III

In some implementations, when one cell group comprise two sets of cells, for example, the cell group comprise cell #0/1/2/3/4/5/6/7, wherein the scheduling cell is cell #0, and the scheduled cell #1/2/3/4/5/6/7 are configured with CIF=1/2/3/4/5/6/7 respectively. First set of cells comprise cell #0/1/2/3, second set of cells comprise cell #4/5/6/7. For both set, the scheduling cell is cell #0. A DCI size of DCI format 0_X/1_X and BD/CCE of DCI format 0_X/1_X is counted on one cell of the set of cells. The DCI size budget for cell #0 can be maintained up to 4 size, the first size is DCI format 0_0/1_0, the second size is DCI format 0_1/1_1, the third size is DCI format 0_2/1_2, the fourth size is DCI format 0_X/1_X if the DCI size of DCI format 0_X/1_X and BD/CCE of DCI format 0_X/1_X is counted on cell #0.

In some implementations, when the first set of cells comprise cell #0/1/2/3, second set of cells comprise cell #0/5/6/7. For both set, the scheduling cell is cell #0. DCI size of DCI format 0_X/1_X and BD/CCE of DCI format (_X/1_X is counted on one cell of the set of cells. DCI size of DCI format 0_X/1_X and BD/CCE of DCI format 0_X/1_X can be counted on same scheduling cell only in one set of cells in case the scheduling cell belongs to more than one set of cells. Otherwise, the DCI size budget for cell #0 may not be maintained up to 4 size, the first size is DCI format 0_0/1_0, the second size is DCI format 0_1/1_1, the third size is DCI format 0_2/1_2, the fourth size is DCI format 0_X/1_X of the first set of cells, the fifth size is DCI format 0_X/1_X of the second set of cells.

### Embodiment Set IV

In some implementations, when each cell of a set of cell is configured with legacy SC scheduling, MC scheduling may be also configured for the set of cells. When calculating M_total/C_total, each scheduled cell number may be counted in M_total_μ/C_total_μ, where the μ is the SCS of the scheduling cell.

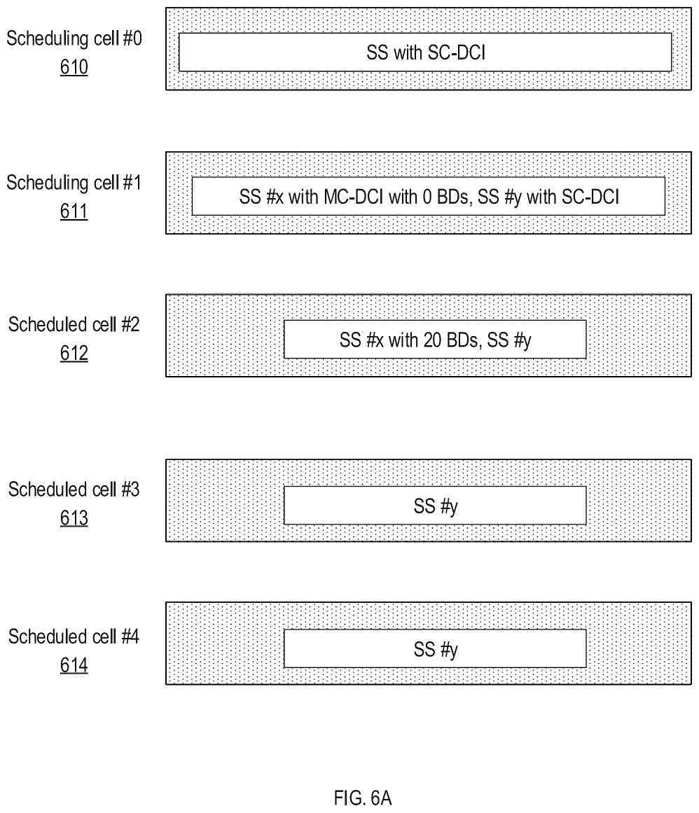

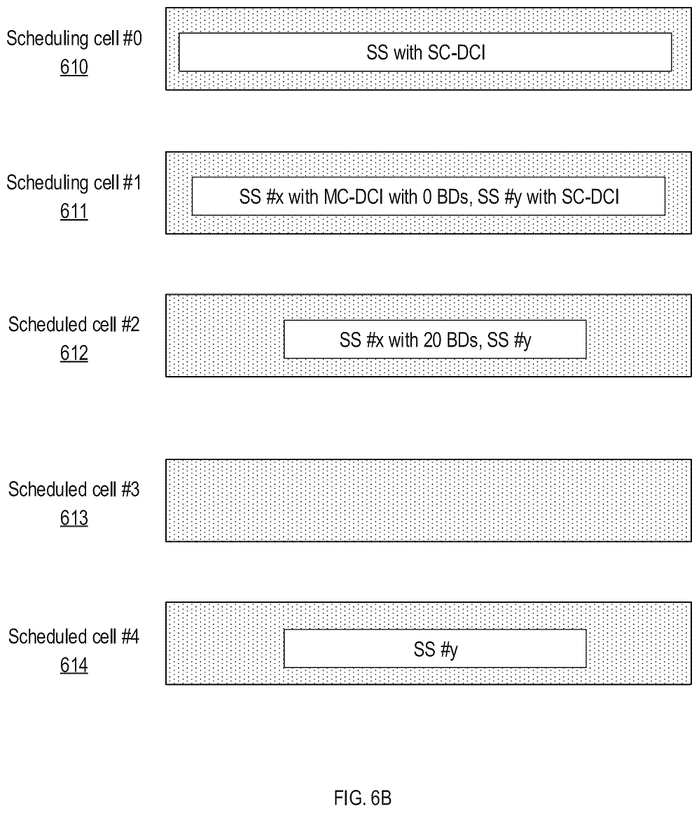

For non-limiting examples as shown in FIGS. 6A and 6B, which includes a scheduling cell (Cell #0, 610) with SCS=15 Khz, another scheduling cell (Cell #1, 611) with SCS=30 Khz, a scheduled cell (Cell #2, 612), another scheduled cell (Cell #3, 613), and another scheduled cell (Cell #4, 614).

As shown in FIG. 6A, Cell #2/3/4 are schedule by cell #1, N_cap=4. M_total_15 khz=floor (4*44*1/5)=35, M_total_30 khz=floor (4*36*4/5)=115 per 4 cells.

In some implementations, one cell of the set of cells is not configured with USS of MC-DCI, and USS of SC-DCI is also not configured on the cell. One of the following methods may be used to determine whether the cell number of the cell is counted in M_total_μ/C_total_μ, wherein the u is the SCS of the scheduling cell.

Method 1: In some implementations, when one cell of the set of cells is not configured with USS of MC-DCI, and USS of SC-DCI is also not configured on the cell, the cell number of the cell is counted in M_total_μ/C_total_u may be determined, where the u is the SCS of the scheduling cell. The cell is counted as one cell for M_total_μ/C_total_u calculation. The associated PDCCH candidates monitored in the active DL BWPs of the scheduling cell including the MC-DCI candidates which is configured on the other cell of the set of cells. The associated PDCCH candidates of MC-DCI monitored on the scheduling cell configured on the other cell (e.g. cell #2) of the set of cells can be also regarded as the candidates of the cell (e.g. cell #3) without any USS configured. As shown in FIG. 6B, there are the scheduling cell #0 with SCS=15 Khz, the scheduling cell #1 with SCS=30 Khz, and cell #2/3/4 are schedule by cell #1, N_cap=4. M_total_15 khz=floor (4*44*1/5)=35, M_total_30 khz=floor (4*36*4/5)=115 per 4 cells.

Method 2: In some implementations, when one cell of the set of cells is not configured with USS of MC-DCI, and USS of SC-DCI is also not configured on the cell, the cell number of the cell is not counted in M_total_μ/C_total_u may be determined, where the u is the SCS of the scheduling cell. The cell is not counted as one cell for M_total_μ/C_total_u calculation. The associated PDCCH candidates monitored in the active DL BWPs of the scheduling cell may not include the MC-DCI candidates which is configured on the other cell of the set of cells. The associated PDCCH candidates of MC-DCI monitored on the scheduling cell configured on the other cell (e.g. cell #2) of the set of cells can not be regarded as the candidates of the cell (e.g. cell #3) without any USS configured. As shown in FIG. 6B, there are the scheduling cell #0 with SCS=15 Khz, the scheduling cell #1 with SCS=30 Khz, and cell #2/3/4 are schedule by cell #1, N_cap=4. N_cell=N_cap, M_total_15 khz=M_max_15 khz=44, M_total_30 khz=M_max_30 khz=36 per cell.

In some implementations, when a UE is configured N_{cells,0}^{DL,μ}+N_{cells,1}^{DL,μ} downlink cells for which the UE is not provided monitoringCapabilityConfig, or is provided monitoringCapabilityConfig=r15monitoringcapability and is not provided coresetPoolIndex, with associated PDCCH candidates monitored in the active DL BWPs of the scheduling cell(s) using SCS configuration μ, where Σ_{μ=0}³(N_{cells,0}^{DL,μ}+γ·N_{cells,1}^{DL,μ})>N_{cells}^{cap}, and a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , slot , μ} = ⌊ {N}_{cells}^{cap} \cdot {M}_{PDCCH}^{max , slot , μ} \cdot ( {N}_{cells , 0}^{DL , μ} + γ \cdot {N}_{cells , 1}^{DL , μ} ) / {\sum }_{j = 0}^{3} ( {N}_{cells , 0}^{DL , j} + γ \cdot {N}_{cells , 1}^{DL , j} ) ⌋$$

PDCCH candidates or more than

$${C}_{PDCCH}^{total , slot , μ} = ⌊ {N}_{cells}^{cap} \cdot {C}_{PDCCH}^{max , slot , μ} \cdot ( {N}_{cells , 0}^{DL , μ} + γ \cdot {N}_{cells , 1}^{DL , μ} ) / {\sum }_{j = 0}^{3} ( {N}_{cells , 0}^{DL , j} + γ \cdot {N}_{cells , 1}^{DL , j} ) ⌋$$

non-overlapped CCEs per slot on the active DL BWP(s) of scheduling cell(s) from the N_{cells,0}^{DL,μ}+N_{cells,1}^{DL,μ} downlink cells. N_{cells}^{cap} is replaced by N_{cells,r15}^{cap-r16} if a UE is configured with downlink cells for which the UE is provided both monitoringCapabilityConfig=r15monitoringcapability and monitoringCapabilityConfig=r16monitoringcapability.

In some implementations, for each scheduled cell from the N_{cells,0}^{DL,μ} downlink cells, the UE is not required to monitor on the active DL BWP with SCS configuration μ of the scheduling cell more than min (M_{PDCCH}^{max,slot,μ}, M_{PDCCH}^{total,slot,μ}) PDCCH candidates or more than min (C_{PDCCH}^{max,slot,μ}, C_{PDCCH}^{total,slot,μ}) non-overlapped CCEs per slot.

In some implementations, for each scheduled cell from the N_{cells,0}^{DL,μ} downlink cells, the UE is not required to monitor on the active DL BWP with SCS configuration u of the scheduling cell more than min (γ·M_{PDCCH}^{max,slot,μ}, M_{PDCCH}^{total,slot,μ}) PDCCH candidates or more than min (γ·C_{PDCCH}^{max,slot,μ}, C_{PDCCH}^{total,slot,μ}) non-overlapped CCEs per slot, and/or more than min (M_{PDCCH}^{max,slot,μ}, M_{PDCCH}^{total,slot,μ}) PDCCH candidates or more than min (C_{PDCCH}^{max,slot,μ}, C_{PDCCH}^{total,slot,μ}) non-overlapped CCEs per slot for CORESETs with same coresetPoolIndex value.

### Embodiment Set V

In some implementations, UL TX switching may be performed within up to configured 2 bands. In various embodiments/implementations in the present disclosure, the term “transmitter” in uplink (UL) transmitter (Tx) switching may be used to refer to a transmitter circuit alone, an antenna component alone, a combination of a transmitter circuit and an antenna component (i.e., a transmitter channel or chain), or the like circuit.

In some implementations, for multi-carrier UL operation, there are some limitations of current specification, e.g. 2TX UE may be configured with at most 2 UL bands, which only can be changed by RRC reconfiguration, and UL Tx switching can be only performed between 2 UL bands for 2Tx UE. Dynamically selecting carriers with UL Tx switching e.g., based on the data traffic, TDD DL/UL configuration, bandwidths and channel conditions of each band, instead of RRC-based cell(s) reconfiguration, may potentially lead to higher UL data rate, spectrum utilization and UL capacity.

In some implementations, UL Tx switching schemes across up to 3 or 4 bands with restriction of up to 2 Tx simultaneous transmission for FRI UEs, including mechanisms to enable more configured UL bands than its simultaneous transmission capability and to support dynamic Tx carrier switching across the configured bands may not be supported by current spec.

In some implementations, when the length of switching period is still applied per band pair for each band combination, the switching gap/period of the 3 or 4 bands involved switching is determined by the larger switching period when two Tx chains are switched between two different band pairs with different lengths of switching periods.

In some implementations, when two Tx chains are switched between two different band pairs with different lengths of switching periods, as baseline UE assumption, neither of the two Tx chains is expected to be used for transmission during the larger one of the two switching periods.

Situation 1: In some implementations, one of the two Tx chains is triggered to switch from one band (named “band A”) to another band (name “band B”), and the other Tx chain is triggered to switch from one band (named “band A”) to another band (name “band C”).

Situation 2: In some implementations, one of the two Tx chains is triggered to switch from one band (named “band A”) to another band (name “band B”), and the other Tx chain is triggered to switch from one band (named “band C”) to another band (name “band D”).

For Situation 1 with 3 bands involved switching, there is no ambiguity issue on switching pattern for each Tx chain.

For Situation 2 with 4 bands involved switching, there may be some ambiguity issue. For the example given above, when Tx switching is conducted across 4 bands and the status of Tx chains before and after Tx switching is: before Tx switching: (band A, band B, band C, band D)=(1, 0, 1, 0); and after Tx switching: (band A, band B, band C, band D)=(0, 1, 0, 1). It is possible that the Tx switching can be conducted from band A to B+C to D or from band A to D+C to B, and the lengths of switching periods can be different.

For a non-limiting example, value 1 for band pair A&B, value 2 for band pair C&D, value 3 for band pair A&D, value 4 for band pair B&C, value 5 for band pair A&C, value 6 for band pair B&D.

For the following switching case of before Tx switching: (band A, band B, band C, band D)=(1, 0, 1, 0) and after Tx switching: (band A, band B, band C, band D)=(0, 1, 0, 1), there are two potential Tx switching routes. For potential Tx switching 1: band A to B+C to D, the switching gap/period is determined by max (value 1, value 2). For potential Tx switching 2: band A to D+C to B, the switching gap/period is determined by max (value 3, value 4).

In some implementations, the switching gap/period of Situation 2 with 4 bands involved switching may be determined by one of following methods.

Method 1: In some implementations, the method includes, based on two Potential switching routes, calculating two switching gaps for each potential switching route; and based on the two switching gaps, deriving the final switching gap. For a non-limiting example, the derived final switching gap may be: Max or Min {Max or Sum (value 1, value 2), Max or Sum (value 3, value 4)}, for example, Max {Max (value 1, value 2), Max (value 3, value 4)}.

Method 2: The ambiguity issue results from that, although Tx chain states are clear, each Tx switched within which band pair is ambiguity. In some implementations, this ambiguity issue may be resolved by RANI by either predefined rules or RRC configuration, and only one of potential switchings may be determined.

In some implementations, a RRC configuration may include two candidate values to indicate one of potential switchings.

In some implementations, a predefined rule may include one of the following: based on cell index from low to high to switch (e.g., cell #1/carrier #1 on band A to cell #2/carrier #2 on band B+ cell #3/carrier #3 on C to cell #4/carrier #4 on band D); based on cell index from high to low to switch (e.g., cell #1/carrier #1 on band A to cell #4/carrier #4 on bandD+ cell #3/carrier #3 on C to cell #2/carrier #2 on band B); and/or based on available band pairs reported in case not all band pairs reported (e.g., when only one band pair B&C is not reported, band A to B+C to D).

### Embodiment Set VI

In some implementations, for 3 or 4 bands involved Tx switching, the following methods for the minimum separation time between two UL Tx switchings across up to 3 or 4 bands may be considered.

Method 1-1: In some implementations, the method includes defining 14 symbols based on a SCS (FFS on SCS) as minimum separation time between two UL Tx switchings.

Method 1-2: In some implementations, the method includes defining that no more than one uplink Tx switching within a reference slot based on a SCS. For one non-limiting example, UL=max (μUL, 1, μUL, 2, μUL, 3, μUL, 4).

Method 1-3: In some implementations, the method includes defining X slots as minimum separation time between two UL Tx switchings where 3 bands are involved in total, and defining Y slots as minimum separation time between two UL Tx switchings where 4 bands are involved in total, wherein X and/or Y is no less than 1.

Method 1-4: In some implementations, the method includes reporting the minimum separation time for different switching cases.

In some implementations, various other methods may be considered to determine the minimum separation time between two UL Tx switchings across up to 3 or 4 bands.

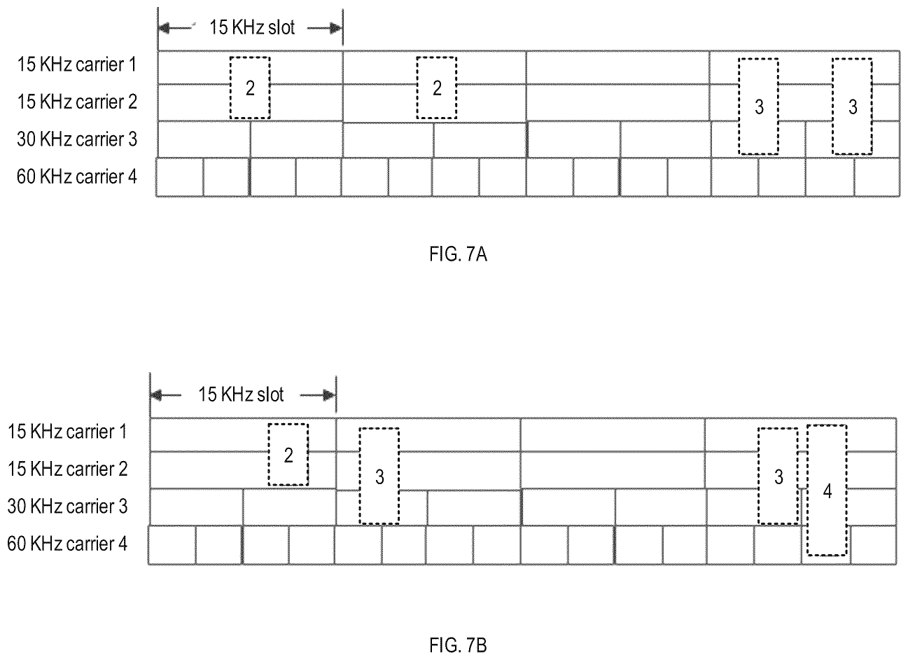

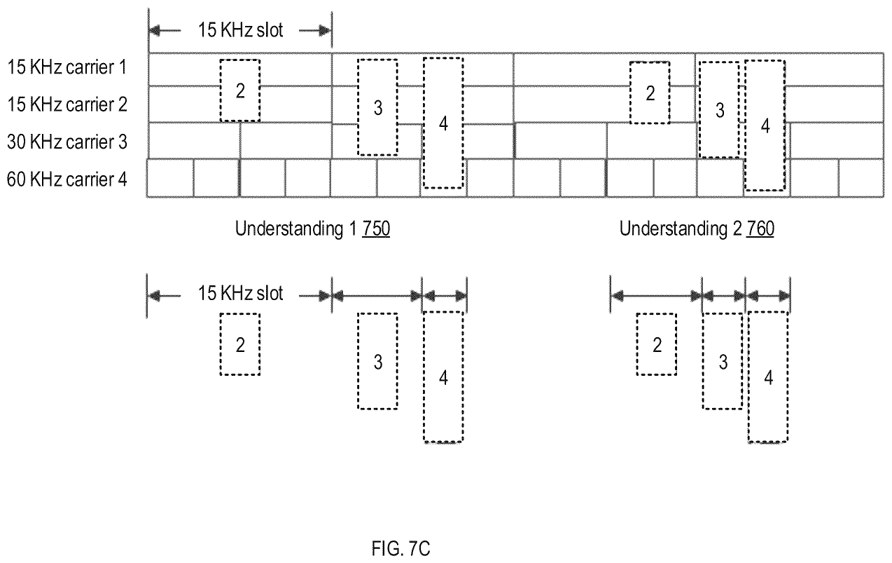

Method 2-1: In some implementations, the method includes defining that no more than one uplink Tx switching within a reference slot based on maximum/minimum SCS of the carriers involved of the two UL Tx switchings. As shown in FIGS. 7A and 7B, a separation between two Tx switchings is clear with same bands involved for the two switchings. For a non-limiting example, when the first UL Tx switching with 2 bands involved, the second UL Tx switching with 3 bands involved, then the reference SCS should take the bands involved in total for consideration. A number in a dotted-line box in FIGS. 7A-7C indicates the number of bands involved in UL Tx switching, for example, a number “3” in a dotted-line box indicates there are 3 bands involved in the particular UL Tx switching.

In some implementations, a separation between two Tx switchings is clear with same bands involved for the two switchings.

In some implementations, when different bands involved for the two switchings, involved bands in total is used.

Method 2-2: In some implementations, the method includes, based on Method 2-1, when the reference SCS for a UL Tx switching calculated with preceding UL Tx switching and as preceding UL Tx switching are different, using the smaller SCS (e.g., Understanding 1, 750 in FIG. 7C) or the larger SCS (e.g., Understanding 2, 760 in FIG. 7C). In some implementations, the method is applicable only for a UL Tx switching calculated with preceding UL Tx switching. In some implementations, the method is applicable only for a UL Tx switching calculated as preceding UL Tx switching. As shown in FIG. 7C, when there are three switchings, first switching with 2 bands involved, second switching with 3 bands involved, and third switching with 4 bands switching, there may two understandings: Understanding 1 (750) and Understanding 2 (760).

Method 2-3: In some implementations, the method includes that a reference slot (e.g., according to Method 1-2) is used when involved bands between two UL Tx switchings are not changed, and a minimum separation time (e.g. according to Method 1-1, 1-3, and/or 1-4) is used when involved bands between two UL Tx switchings are changed. In some implementations, the method includes that a reference slot (e.g., according to Method 1-2) is used when involved bands between two UL Tx switchings are changed, and a minimum separation time (e.g. according to Method 1-1, 1-3, and/or 1-4) is used when involved bands between two UL Tx switchings are not changed.

### Embodiment Set VII

In some embodiments, the network may configure a first codebook for a user equipment (UE). The first codebook may include a plurality of hybrid automatic repeat request acknowledgement (HARQ-ACK) information bits. The network may configure that the first codebook at least includes a first sub-codebook and a second sub-codebook. The first codebook may be formed by concatenating the first sub-codebook and the second sub-codebook. For example, the HARQ-ACK information bits of the first sub-codebook may be appended to the HARQ-ACK information bits of the second sub-codebook, or the HARQ-ACK information bits of the second sub-codebook may be appended to the HARQ-ACK information bits of the first sub-codebook.

The network may configure one or more serving cells for the UE. Each serving cell may have a serving cell index. The network may activate or deactivate the serving cell via medium access control (MAC) control element (CE), or downlink control information (DCI), or radio resource control (RRC) signaling. After activation, the serving cell may be activated cell. After deactivation, the serving cell may be deactivated cell.

The network may send a DCI to the UE. A first DCI may schedule only one physical downlink shared channel (PDSCH). A second DCI may schedule more than one PDSCHs. A PDSCH may carry one or two transport blocks. In any embodiment, a PDSCH can be replaced by one or two transport blocks carried by the PDSCH and meaning does not change. The first DCI and the second DCI may have different DCI formats or the same DCI format. The more than one PDSCHs may be transmitted on one serving cell. Alternatively, the more than one PDSCHs may be transmitted on more than one serving cells. The more than one PDSCHs may be transmitted on respective serving cells.

The first sub-codebook may include the HARQ-ACK information bit(s) corresponding to the PDSCH scheduled by the first DCI. The second sub-codebook may include the HARQ-ACK information bit(s) corresponding to the PDSCH scheduled by the second DCI.

In some embodiments, the second DCI may schedule a plurality of PDSCHs or physical uplink shared channels (PUSCHs) on a plurality of serving cells. Within the plurality of serving cells, only one cell is activated cell. The PDSCH or PUSCH scheduled on the deactivated cells may not be transmitted. From the UE perspective, the UE may not receive the PDSCH scheduled on the deactivated cell. The UE may not transmit the PUSCH scheduled on the deactivated cell.

In the first case, the HARQ-ACK information bits corresponding to the plurality of PDSCHs (or the second DCI) may be included in the first sub-codebook. The HARQ-ACK information bits corresponding to the plurality of PDSCHs (or the second DCI) may only include the HARQ-ACK information for the PDSCH scheduled on the activated cell.

In the second case, the HARQ-ACK information bits corresponding to the plurality of PDSCHs (or the second DCI) may be included in the second sub-codebook. The HARQ-ACK information bits corresponding to the plurality of PDSCHs (or the second DCI) may only include the HARQ-ACK information for the plurality of PDSCHs. The order of the HARQ-ACK information bits corresponding to the plurality of PDSCHs (or the second DCI) may be based on the serving cell index for the plurality of PDSCHs. More specifically, the HARQ-ACK information bits corresponding to the plurality of PDSCHs (or the second DCI) may be constructed in the increasing (or decreasing) order of the serving cell index. For the PDSCH scheduled on the deactivated cell, the corresponding HARQ-ACK information is NACK. It implies the value of HARQ-ACK information corresponding to the PDSCH scheduled on deactivated cell is ‘0’.

For example, a DCI schedules three PDSCHs on three cells, in which PDSCH 0 is scheduled on cell 0, PDSCH 1 is scheduled on cell 1, PDSCH 2 is scheduled on cell 2. Cell 0 and cell 2 are deactivated cells. Cell 1 is activated cell. A PDSCH correspond to one 1 bit.

In the first case, the HARQ-ACK corresponding to the DCI (or the three PDSCHs) only includes the HARQ-ACK information for PDSCH 1. If PDSCH 1 is decoded correctly, the HARQ-ACK corresponding to the DCI (or the three PDSCHs) is ‘1’. If PDSCH 1 is not decoded correctly, the HARQ-ACK corresponding to the DCI (or the three PDSCHs) is ‘0’.

In the second case, the HARQ-ACK corresponding to the DCI (or the three PDSCHs) includes the HARQ-ACK information for PDSCH 0, PDSCH 1, and PDSCH 2. The HARQ-ACK information for PDSCH 0, PDSCH 2 are ‘0’, respectively. When PDSCH 1 is decoded correctly, the HARQ-ACK information bits are ‘010’, where the first bit corresponds to PDSCH 1, the second bit correspond to PDSCH 2, and the third bit corresponds to PDSCH 2. When PDSCH 2 is not decoded correctly, the HARQ-ACK information bits are ‘000’, where the first bit corresponds to PDSCH 1, the second bit correspond to PDSCH 2, and the third bit corresponds to PDSCH 2.

In some embodiments, the network may indicate whether the HARQ feedback is enabled for a HARQ process via DCI, MAC CE or RRC signaling. A HARQ process may be identified by a HARQ process number. If the network indicates that HARQ feedback is not enabled (e.g., disabled) for a HARQ process, the UE may not transmit HARQ-ACK information for the transport block for the HARQ process. If the network indicates that HARQ feedback is enabled for a HARQ process, the UE may transmit the HARQ-ACK information for the transport block for the HARQ process.

The second DCI may schedule a plurality of PDSCHs on a plurality of serving cells. Each PDSCHs may be associated with an HARQ process number. If at least one PDSCH among the plurality of PDSCHs is associated with a HARQ process with enabled feedback, the UE may transmit the HARQ-ACK information for the plurality of PDSCH. For a PDSCH associated with a HARQ process with disabled HARQ feedback, ‘NACK’ may be included in the corresponding HARQ-ACK information.

Within the plurality of PDSCHs, only one PDSCH may be associated with HARQ process with enabled HARQ feedback. The other PDSCHs may be associated with HARQ process with disabled HARQ feedback. In the first case, the HARQ-ACK information bits corresponding to the plurality of PDSCHs (or the second DCI) may be included in the first sub-codebook. The HARQ-ACK information bits corresponding to the plurality of PDSCHs (or the second DCI) may only include the HARQ-ACK information for the PDSCH associated with HARQ process with disabled HARQ feedback.

In the second case, the HARQ-ACK information bits corresponding to the plurality of PDSCHs (or the second DCI) may be included in the second sub-codebook. The HARQ-ACK information bits corresponding to the plurality of PDSCHs (or the second DCI) may only include the HARQ-ACK information for the plurality of PDSCHs. The order of the HARQ-ACK information bits corresponding to the plurality of PDSCHs (or the second DCI) may be based on the serving cell index for the plurality of PDSCHs. More specifically, the HARQ-ACK information bits corresponding to the plurality of PDSCHs (or the second DCI) may be constructed in the increasing (or decreasing) order of the serving cell index. Alternatively, the order of the HARQ-ACK information bits corresponding to the plurality of PDSCHs (or the second DCI) may be based on the slot index for the plurality of PDSCHs. More specifically, the HARQ-ACK information bits corresponding to the plurality of PDSCHs (or the second DCI) may be constructed in the increasing (or decreasing) order of the slot index. Additionally, the HARQ-ACK information bits corresponding to the plurality of PDSCHs (or the second DCI) may be constructed first in the increasing (or decreasing) order of the slot index, second in the increasing (or decreasing) order of the serving cell index. For a PDSCH associated with a HARQ process with disabled HARQ feedback, ‘NACK’ may be included in the corresponding HARQ-ACK information.

In some embodiments, the network may configure a second codebook for a UE. The second codebook may include the HARQ-ACK information for the transport blocks for a plurality of HARQ processes for a plurality of serving cells. The second codebook may be constructed by concatenating the HARQ-ACK information in the order of at least HARQ process number, or serving cell index. For example, it may be constructed first in the increasing (or decreasing) order of the HARQ process number, second in the increasing (or decreasing) order of the HARQ process number.

In the first case, the network may indicate that HARQ feedback is enabled for a first HARQ process. If the UE has obtained HARQ-ACK information for the transport block for the first HARQ process and has not reported the HARQ-ACK information for the first HARQ process, the HARQ-ACK information for the transport block for the first HARQ process may be included in the second codebook. In other words, when the UE decodes the transport block correctly for the first HARQ process, ‘ACK’ for the transport block for the first HARQ process may be included in the second codebook. When the UE does not decode the transport block correctly for the first HARQ process, ‘NACK’ for the transport block for the first HARQ process may be included in the second codebook. Otherwise (e.g., the UE has not obtained HARQ-ACK information for the transport block for the first HARQ process, or the UE has reported the HARQ-ACK information for the first HARQ process), ‘NACK’ for the transport block for the first HARQ process may be included in the second codebook. The network may indicate that the HARQ feedback is not enabled for a second HARQ process. ‘NACK’ for the transport block for the second HARQ process may be included in the second codebook.

In the second case, the new data indicator (NDI) value for each transport block for each HARQ process may be also included in the second codebook. If the UE has the HARQ-ACK information for the transport block for the HARQ process, the HARQ-ACK information for the transport block for the HARQ process may be included in the second codebook regardless whether the HARQ feedback for the HARQ process is enabled or disabled.

The present disclosure describes methods, apparatus, and computer-readable medium for wireless communication. The present disclosure addressed the issues with multiple carrier transmission. The methods, devices, and computer-readable medium described in the present disclosure may facilitate the performance of wireless communication by resolving issues/problems associated with multiple carrier transmission, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1-25. (canceled)

26. A method for wireless communication, performed by a wireless communication device, comprising:
receiving a configuration of a value for a set of cells, and
receiving a configuration of a search space of a multi-cell scheduling downlink control information (MC-DCI),
wherein:
the set of cells is configured for multi-cell scheduling and at least one of the set of cells are scheduled by the MC-DCI on a physical downlink control channel (PDCCH) candidate on a scheduling cell.

27. The method according to claim 26, wherein:
a user equipment-specific search space (USS) is not configured for a scheduled cell in the set of cells; and
a calculation of a total candidate number excludes the scheduled cell.

28. The method according to claim 27, wherein:
the USS comprises the USS of the MC-DCI and the USS of a single-cell scheduling downlink control information (SC-DCI).

29. The method according to claim 27, wherein:
the total candidate number comprises at least one of the following:
M_total_μ indicating a total PDCCH candidates for a DL BWP with a SCS configuration, and
C_total_μ indicating a total CCEs for a DL BWP with a SCS configuration.

30. The method according to claim 26, wherein:
a USS is configured for a scheduled cell in the set of cells; and
a calculation of a total candidate number includes the scheduled cell.

31. The method according to claim 30, wherein:
the USS comprises at least one of the following: the USS of the MC-DCI and the USS of a SC-DCI.

32. The method according to claim 30, wherein:
the total candidate number comprises at least one of the following:
M_total_μ indicating a total PDCCH candidates for a DL BWP with a SCS configuration, and
C_total_μ indicating a total CCEs for a DL BWP with a SCS configuration.

33. The method according to claim 26, wherein:
the value is used to determine CCE indexes of the search space corresponding to the PDCCH candidate, and
the search space is configured on at least one of the following: the scheduling cell carrying the MC-DCI or a scheduled cell in the set of cells.

34. A wireless communication device comprising:
a memory storing instructions; and
at least one processor in communication with the memory, wherein, when the at least one processor executes the instructions, the at least one processor is configured to cause the wireless communication device to perform:
receiving a configuration of a value for a set of cells, and
receiving a configuration of a search space of a multi-cell scheduling downlink control information (MC-DCI),
wherein:
the set of cells is configured for multi-cell scheduling and at least one of the set of cells are scheduled by the MC-DCI on a physical downlink control channel (PDCCH) candidate on a scheduling cell.

35. The wireless communication device according to claim 34, wherein:
a user equipment-specific search space (USS) is not configured for a scheduled cell in the set of cells; and
a calculation of a total candidate number excludes the scheduled cell.

36. The wireless communication device according to claim 35, wherein:
the USS comprises the USS of the MC-DCI and the USS of a SC-DCI.

37. The wireless communication device according to claim 35, wherein:
the total candidate number comprises at least one of the following:
M_total_μ indicating a total PDCCH candidates for a downlink (DL) bandwidth part (BWP) with a subcarrier spacing (SCS) configuration, and
C_total_μ indicating a total control channel elements (CCEs) for a DL BWP with a SCS configuration.

38. The wireless communication device according to claim 34, wherein:
a USS is configured for a scheduled cell in the set of cells; and
a calculation of a total candidate number includes the scheduled cell.

39. The wireless communication device according to claim 38, wherein:
the USS comprises at least one of the following: the USS of the MC-DCI and the USS of a SC-DCI.

40. The wireless communication device according to claim 38, wherein:
the total candidate number comprises at least one of the following:
M_total_μ indicating a total PDCCH candidates for a DL BWP with a SCS configuration, and
C_total_μ indicating a total CCEs for a DL BWP with a SCS configuration.

41. The wireless communication device according to claim 34, wherein:
the value is used to CCE indexes of the search space corresponding to the PDCCH candidate, and
the search space is configured on at least one of the following: the scheduling cell carrying the MC-DCI or a scheduled cell in the set of cells.

42. A method for wireless communication, performed by a wireless communication node, comprising:
sending a configuration of a value for a set of cells to a user equipment (UE), and
sending a configuration of a search space of a multi-cell scheduling downlink control information (MC-DCI) to the UE,
wherein:
the set of cells is configured for multi-cell scheduling and at least one of the set of cells are scheduled by the MC-DCI on a physical downlink control channel (PDCCH) candidate on a scheduling cell.

43. The method according to claim 42, wherein:
a USS is configured for a scheduled cell in the set of cells; and
a calculation of a total candidate number includes the scheduled cell,
wherein:
the USS comprises at least one of the following: the USS of the MC-DCI and the USS of a SC-DCI, and
the total candidate number comprises at least one of the following:
M_total_μ indicating a total PDCCH candidates for a DL BWP with a SCS configuration, and
C_total_μ indicating a total CCEs for a DL BWP with a SCS configuration.

44. A wireless communication node comprising:
a memory storing instructions; and
at least one processor in communication with the memory, wherein, when the at least one processor executes the instructions, the at least one processor is configured to cause the wireless communication node to perform:
sending a configuration of a value for a set of cells to a user equipment (UE), and
sending a configuration of a search space of a multi-cell scheduling downlink control information (MC-DCI) to the UE,
wherein:
the set of cells is configured for multi-cell scheduling and at least one of the set of cells are scheduled by the MC-DCI on a physical downlink control channel (PDCCH) candidate on a scheduling cell.

45. The wireless communication node according to claim 44, wherein:
a USS is configured for a scheduled cell in the set of cells; and
a calculation of a total candidate number includes the scheduled cell,
wherein:
the USS comprises at least one of the following: the USS of the MC-DCI and the USS of a SC-DCI, and
the total candidate number comprises at least one of the following:
M_total_μ indicating a total PDCCH candidates for a DL BWP with a SCS configuration, and
C_total_μ indicating a total CCEs for a DL BWP with a SCS configuration.
